(19) United States
(12) Patent Application Publication
(10) Pub. No.: US 2012/0107685 A1
(43) Pub. Date: May 3, 2012

(54) ELECTROPOSTIVE PLATE, BATTERY, VEHICLE BATTERY-MOUNTED DEVICE, AND ELECTROPOSITIVE PLATE MANUFACTURING METHOD

(76) Inventors: Takumi Tamaki, Aichi (JP); Takayuki Shirane, Aichi (JP); Hiroaki Imanishi, Aichi (JP); Kazuhiro Okawa, Aichi (JP)

(21) Appl. No.: 13/379,108

(22) PCT Filed: Jun. 26, 2009
(86) PCT No.: PCT/JP2009/061706

§ 371 Date: Dec. 19, 2011

(51) Int. Cl. H01M 4/38; H01M 4/60; H01M 4/62; B05D 5/12; B05D 3/00

(52) U.S. Cl. 429/213; 427/58; 429/217; 429/220

(57) ABSTRACT

Provided is a positive electrode plate, which is high in the peeling strength of an anode activating substance layer and which is suppressed in the increase of a battery resistance. Also provided are a battery using the positive electrode plate, a vehicle having the battery mounted thereon, a battery-mounting device, and a positive electrode plate manufacturing method capable of manufacturing the anode activating substance layer properly. The positive electrode plate includes a substrate having conductivity, and a positive electrode active material layer formed in the substrate and containing positive electrode active material particles, a conductive material and binders. These binders are made of either only polyethylene oxide, or only polyethylene oxide and carboxymethyl cellulose.

### CROSS-REFERENCE TO RELATED APPLICATIONS

This application is a national phase application of International Application No. PCT/JP2009/061706, filed Jun. 26, 2009, the contents of which are incorporated herein by reference.

### TECHNICAL FIELD

The present invention relates to a positive electrode plate including a substrate and a positive active material layer formed on this substrate, a battery using this positive electrode plate. Further, the present invention relates to a method of manufacturing such a positive electrode plate.

### BACKGROUND ART

In recent years, lithium ion secondary batteries (hereinafter, also simply referred to as batteries) are utilized as drive power sources of hybrid electric vehicles and portable electronic devices such as note-sized personal computers and video camcorders.

For such batteries, for example, Patent Document 1 discloses a positive electrode (a positive electrode plate) including an active material layer (a positive active material layer) containing a binder consisting of only carboxymethyl cellulose (hereinafter, also referred to as CMC) on a conductive layer (a carbon coat layer).

### RELATED ART DOCUMENTS

### Patent Documents

Patent Document 1: JP 2006-4739 A

### DISCLOSURE OF THE INVENTION

### Problems to be Solved by the Invention

In the aforementioned battery, the positive active material layer being formed on the carbon coat layer, the peel strength of the positive active material layer can be enhanced. However, CMC used as the binder is apt to change its structure for example in the presence of alkaline materials such as lithium complex oxides. Accordingly, the viscosity of CMC will become lower as compared to other binders such as polyethylene oxide (hereinafter, also referred to as PEO). When manufacturing the positive electrode plate disclosed in Patent Document 1, therefore, the viscosity of an active material paste prepared by kneading CMC (the binder), the positive active material particles, the conductive material, and a solvent will also become lower. In such an active material paste, the active materials may settle out. Even when this active material paste is applied on the substrate, the paste may spread wider than an applied area or flow down from the substrate before being dried.

Furthermore, the viscosity of CMC contained in the active material paste will extremely lower as time advances. When manufacturing the positive electrode plate, the active material paste has to be applied promptly after kneading. An active material paste left standing for a while after kneading decreases in viscosity and thus is unavailable to a coating process. Therefore, the efficiency in producing (manufacturing) a positive electrode plate would be deteriorated.

Patent Document 1 also shows for example polytetrafluoroethylene (hereinafter, also referred to as PTFE) as an example of the binder in the positive active material layer. However, if an active material paste is prepared by using this PTFE as the binder, PTFE particles and a conductive material are apt to cling together into aggregates in the active material paste. In the case of using acetylene black as the conductive material, for instance, the PTFE particles is less likely to disperse in the active material paste and a part thereof will cling together with acetylene black into relatively large aggregates (Particle diameter: 50 μm or more).

For manufacturing a positive electrode plate, when an active material paste containing such aggregates is applied, the aggregates are apt to be scattered or dotted and thus this paste could not be applied thinly and uniformly on the substrate. Consequently, reactions of the positive active material layer associated with charge and discharge will vary from portion to portion. Consequently, the property of the positive electrode plate and hence the property of the battery using such a positive electrode plate are unstable. In some cases, this active material paste is passed through a filter to remove foreign substances. If aggregates have been generated, the filter is likely to be clogged with the aggregates, thus decreasing the amount of the active material paste allowed to pass. This may also decrease the productivity.

It has been found that, as compared to the case of using PTFE together with CMC and PEO, the peel strength of a positive active material layer not containing PTFE could be made higher and a battery resistance change rate (calculated by dividing a battery resistance value by an initial battery resistance value of the battery) could be made lower.

The present invention has been made in view of the circumstances and has a purpose to provide a positive electrode plate in which the peel strength of a positive active material layer is high and a battery resistance is prevented from increasing, a battery using this positive electrode plate. Another purpose is to provide a positive electrode plate manufacturing method capable of appropriately manufacturing a positive active material layer.

### Means of Solving the Problems

One aspect of the invention provides a positive electrode plate including: a substrate made of aluminum; and a positive active material layer formed on the substrate, the layer containing positive active material particles, a conductive material, and a binder, wherein a carbon coat layer containing carbon powder is interposed between the substrate and the positive active material layer, and wherein the binder consists of polyethylene oxide or polyethylene oxide and carboxymethyl cellulose.

Meanwhile, it has been found that a battery using a positive electrode plate including a positive active material layer containing PEO or PEO and CMC as a binder could make the peel strength of the positive active material layer higher and the battery resistance change rate lower as compared to a battery including a positive active material layer containing PTFE as well as PEO and CMC. Such a battery can also make the peel strength higher and the battery resistance change rate lower as compared to a battery disclosed in Patent Document 1, that is, a battery including a binder containing only CMC.

The aforementioned positive electrode plate can more improve the peel strength of the positive active material layer and prevent an increase in battery resistance than a positive electrode plate including a positive active material layer containing PTFE as a binder or a positive active material layer containing only CMC as a binder.

Further, in forming this positive active material layer, aggregates deriving from PTFE are not generated in the active material paste. Specifically, in this positive electrode plate, the active material paste can be applied uniformly on the substrate while preventing the generation of such aggregates. Accordingly, the use of this positive electrode plate can stabilize the battery property.

Further, in the aforementioned positive electrode plate, the carbon coat layer is interposed between the substrate and the positive active material layer. This can relatively increase bonding strength between the substrate and the positive active material layer.

The conductive material contained in the positive active material layer may include, for example, the aforementioned carbon particles, and metal particles such as nickel particles.

The positive active material particles may include, for example, lithium transition metal complex oxide particles such as lithium cobalt oxide, lithium nickel oxide, and lithium manganate oxide, and iron-olivine compound.

The carbon particles contained in the carbon coat layer may include carbon black such as acetylene black, furnace black, and ketchen black, and graphite powder.

Further, in the above positive electrode plate, preferably, the binder consists of only polyethylene oxide and carboxymethyl cellulose.

It has been found that a battery including a positive electrode plate including a positive active material layer containing only PEO and CMC as a binder could reduce its battery resistance change rate as compared to a battery using a positive electrode plate including a positive active material layer containing only PEO as a binder. From this, when the aforementioned positive electrode plate is used in the battery, the battery can prevent an increase in battery resistance.

Further, in one of the above positive electrode plates, preferably, the positive active material layer contains the polyethylene oxide and the carboxymethyl cellulose respectively by 1 wt %.

It has been found that a battery including a positive electrode plate including a positive active material layer containing PEO and CMC as a binder respectively by 1 wt % could more reduce its battery resistance change rate than not only a battery using including a positive active material layer containing only CMC but also a battery including a positive active material layer containing only PEO. In the case of containing only CMC, a coating amount of each positive active material particle is small, thus deteriorating the surface of each positive active material particle. Reversely, in the case of containing only PEO, it is conceivable that a coating amount of each positive active material particle increases, the area involved in battery reaction, of the surface area of each particle, becomes narrower, and repeated charge and discharge of the battery likely deteriorates the inside of each positive active material particle. From this, when the aforementioned positive electrode plate is used in the battery, the battery can prevent an increase in battery resistance.

Moreover, another aspect of the invention provides a battery using the positive electrode plate described and a negative electrode plate including: a copper substrate for negative electrode plate, a negative active material layer containing negative active material particles consisting of graphite and a binder; and a ceramic coat layer formed on the negative active material layer, wherein when, before and after a cycle test in which constant current charge and constant current discharge are repeated alternately 2000 times each at a current value of 1 C in a range of 0 to 100% of a state of charge (SOC) of the battery, the battery in 30% SOC is subjected to the constant current discharge at a current value of 30 C, a voltage value at a lapse of ten seconds from a start of discharge is measured, and resistance values of the battery before and after the cycle test are calculated respectively, a battery resistance change rate calculated by dividing the resistance value after the cycle test by the resistance value before the cycle test is in a range of 100% to 110%.

The above battery uses the aforementioned positive electrode plate and the negative electrode plate including the copper substrate for negative electrode plate, the negative active material layer, and the ceramic coat layer formed on the negative active material layer. This battery has a property that the battery resistance change rate before and after the cycle test are in a range of 100 to 110%. Accordingly, a battery that has high peel strength of the positive active material layer and prevents an increase in battery resistance can be achieved.

Alternatively, it is preferable that a vehicle mounts the aforementioned battery and uses electric energy of the battery as all or part of drive sources.

Since the above vehicle mounts the aforementioned battery, that is, the battery using the aforementioned positive electrode plate, a vehicle that prevents deterioration in driving performance can be achieved.

The vehicle may be any of the vehicles that use electrical energy by batteries for all or part of their power sources, including, for example, electric cars, hybrid cars, plug-in hybrid cars, hybrid railway vehicles, fork lifts, electric wheelchairs, electric bicycles, electric scooters.

Alternatively, preferably, a battery-mounting device mounts the aforementioned and uses electric energy of the battery as all or part of energy sources.

Since the above battery-mounting device that mounts the aforementioned battery, that is, the battery using the aforementioned positive electrode plate, a battery-mounting device that prevents deterioration in property can be achieved.

The battery-mounting device may be any of the devices that have a battery mounted thereon and use it for all or part of their energy sources, including, for example, various battery-powered domestic and office appliances and industrial equipment, such as personal computers, mobile phones, battery-powered electric tools, uninterruptible power supplies.

Further, another aspect of the invention provides a method of manufacturing a positive electrode plate including: a substrate made of aluminum; and a positive active material layer formed on the substrate, the layer containing positive active material particles, a conductive material, and a binder, wherein a carbon coat layer containing carbon powder is interposed between the substrate and the positive active material layer, wherein the binder consists of polyethylene oxide or polyethylene oxide and carboxymethyl cellulose, and wherein the method includes a positive active material layer forming process of forming the positive active material layer by: applying, onto the carbon coat layer formed in advance on the substrate, an active material paste prepared by kneading the positive active material particles, the conductive material, and the binder, and; then drying the active material paste.

The above method of manufacturing a positive electrode plate includes the positive active material layer forming step in which the active material paste containing PEO or PEO and CMC as the binder is applied on the carbon coat layer formed in advance on the substrate, this substrate is then dried to form the positive active material layer. This method therefore can manufacture the positive electrode plate including the positive active material layer having good peel strength and maintaining an appropriate shape on the substrate.

Further, PEO has higher alkali resistance than CMC has. In the case where PEO or PEO and CMC are used as the binder, even when they are mixed with alkaline positive active material particles, the viscosity more slowly decreases in the active material paste as time passes than in the case of using only CMC. Accordingly, in manufacturing the positive electrode plate, for example, even when the active material paste produced in advance is sequentially applied on the substrate, a positive electrode plate can be manufactured efficiently with the viscosity of the active material paste that will less change and the thickness of the positive active material layer and others that is less likely to vary.

Since the positive electrode plate including the positive active material layer using PEO or PEO and CMC as the binder is used in a battery, this can also provide an advantage that can prevents an increase in battery resistance. Further, since the active material paste does not contain PTFE, no aggregates will be generated in the active material paste and the uniform active material paste can be applied thinly and uniformly.

Furthermore, according to the above method of manufacturing a positive electrode plate, in the positive active material layer forming step, the paste is applied on the carbon coat layer formed on the substrate. This can reliably enhance bonding strength between the formed positive active material layer and the substrate.

The aforementioned positive electrode plate manufacturing method, preferably, including: prior to the positive active material layer forming process, a filtering process of passing the kneaded active material paste through a filter, the filter having an index of trapping efficiency of 90% being 50 μm or less.

The above method of manufacturing a positive electrode plate includes the aforementioned filtering process. It is therefore possible to remove foreign substances by the filter and also effectively remove the foreign substances without clogging with aggregates.

The filter has an index of a trapping efficiency of 90% being 50 μm or less. To be concrete, the filter may include a multi-layered nonwoven roll made of polypropylene or polyethylene, a single-layered nonwoven pleat, and a spool-type filter.

### BRIEF DESCRIPTION OF THE DRAWINGS

FIG. 1 is a perspective view of a battery in a first embodiment;

FIG. 2 is a perspective view of a negative electrode plate in the first embodiment;

FIG. 3 is a perspective view of a positive electrode plate in the first embodiment;

FIG. 4 is an enlarged cross-sectional view (a part A in FIG. 3) of the positive electrode plate in the first embodiment;

FIG. 5 is a perspective view of the positive electrode plate in the first embodiment;

FIG. 6 is a perspective view of the positive electrode plate in the first embodiment;

FIG. 7 is an explanatory view of a positive active material layer forming process for the positive electrode plate in the first embodiment;

FIG. 8 is an explanatory view of the positive active material layer forming process for the positive electrode plate in the first embodiment;

FIG. 9 is an explanatory view of a viscometer;

FIG. 10 is a graph showing changes in viscosity of an active material paste according to a length of standing time;

FIG. 11 is an explanatory view of a positive active material layer forming process for the positive electrode plate in the first embodiment;

FIG. 12 is an explanatory view of a positive active material layer forming process for the positive electrode plate in the first embodiment;

FIG. 13 is an explanatory view of a vehicle in a first referential embodiment; and

FIG. 14 is an explanatory view of a battery-mounting device in a second referential embodiment.

### DESCRIPTION OF THE REFERENCE SIGNS

1, 101, 201 Battery
30, 130, 230 Positive electrode plate
31, 131, 231 Positive active material layer
31P, 131P, 231P Active material paste
32A First binder (Binder)
32B Second binder (Binder)
35 Conductive material
36, 236 Positive active material particles
37 Carbon coat layer
38 Aluminum foil (Substrate)
CP Carbon particles
400 Vehicle
500 Hammer drill (Battery-mounting device)
910 Filter

### MODE FOR CARRYING OUT THE INVENTION

### First Embodiment

A detailed description of a first embodiment of the present invention will now be given referring to the accompanying drawings.

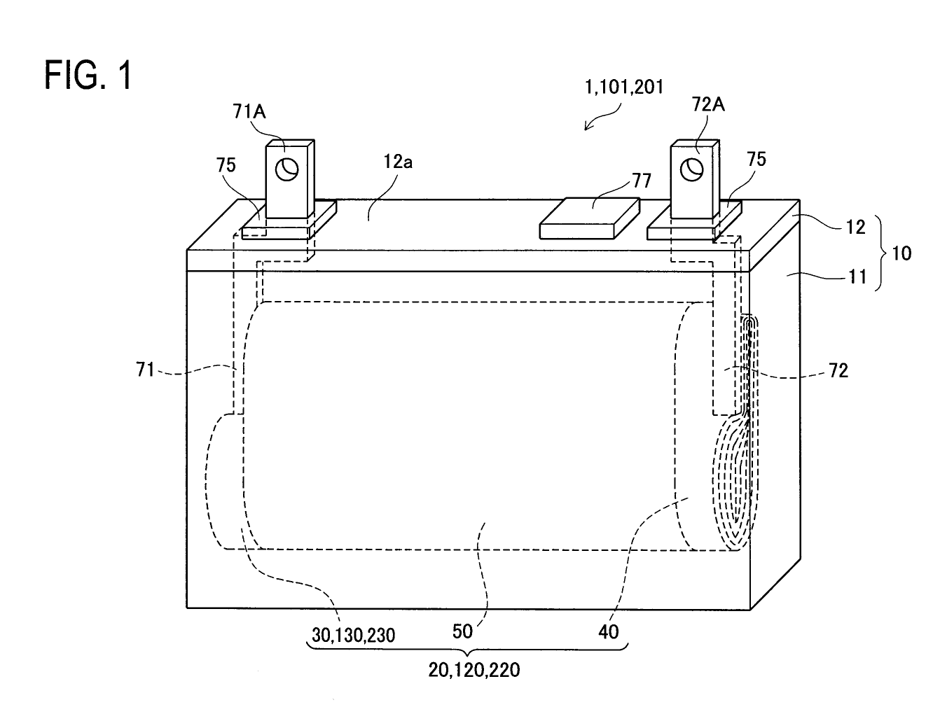

A first explanation is made to a battery 1 (Example 1) including a positive electrode plate 30 in the first embodiment. FIG. 1 is a perspective view of the battery 1 of Example 1.

This battery 1 is a wound-type lithium ion secondary battery including, in addition to the positive electrode plate 30, a power generating element 20 having a negative electrode plate 40 and a separator 50, and an electrolyte not shown (see FIG. 1). In this battery 1, the power generating element 20 and the electrolyte (not shown) are housed in a battery case 10 shaped like a rectangular box. This battery case 10 has a case body 11 and a closing lid 12, both of which are made of aluminum. The case body 11 is of a bottom-closed rectangular box-like shape. Between this battery case 10 and the power generating element 20, an insulation film (not shown) made of resin and bent in a box-like shape is interposed.

Further, the closing lid 12 is of a rectangular plate-like shape, placed to close the opening of the case body 11 and welded thereto. Of a positive current collector 71 and a negative current collector 72 each connected to the power generating element 20, a positive terminal portion 71A and a negative terminal portion 72A located at respective leading ends pass through the closing lid 12 so as to protrude upward from a lid top surface 12a in FIG. 1. Insulation members 75 made of insulating resin are interposed respectively between the positive terminal portion 71A and the lid 12 and between the negative terminal portion 72A and the lid 12 for insulation. Further, on this lid 12, a rectangular plate-like safety valve 77 is also sealingly attached.

The electrolyte not shown is an organic electrolyte prepared by adding LiPF₆ as a solute to a mixed organic solvent prepared from ethylene carbonate (EC), ethylmethyl carbonate (EMC), and dimethyl carbonate (DMC) at a volume ratio of EC:EMC:DMC=1:3:3, and so that lithium ion concentration is 1 mol/l.

In the power generating element 20, a negative electrode plate 40 and a positive electrode plate 30, each having a strip shape, are wound in a flat shape by interposing a stripe-shaped separator 50 made of polyethylene (see FIG. 1). The positive electrode plate 30 and the negative electrode plate 40 of this power generating element 20 are joined respectively to the positive current collector 71 and the negative current collector 72 each being a crank-like bent plate.

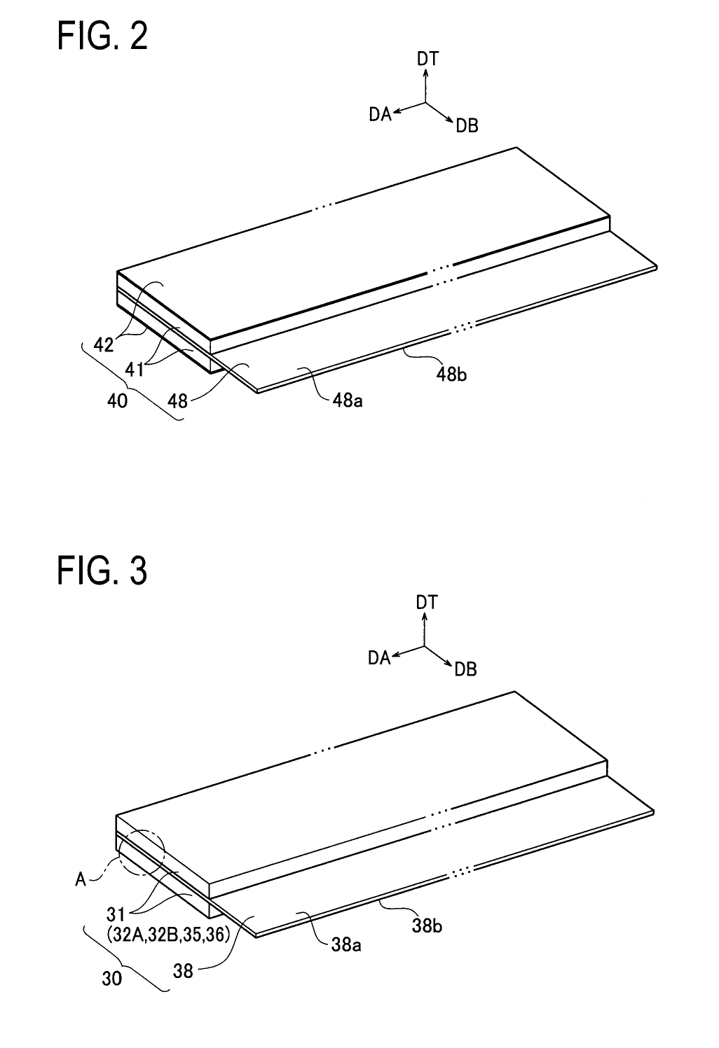

The negative electrode plate 40 of the power generating element 20 includes, as shown in FIG. 2, a copper foil 48 made of copper and shaped like a strip extending in a longitudinal direction DA, two negative active material layers 41 laminated respectively on a first main surface 48a and a second main surface 48b of the copper foil 48, and ceramic coat layers 42 formed respectively on the negative active material layers 41.

The ceramic coat layers 42 are made of alumina and polyvinylidene fluoride (PVDF). Even if the separator 50 is contracted or broken due to short-circuit caused by small holes in the separator 50 and foreign substances, the ceramic coat layers 42 can prevent widening of such a short-circuit point. Furthermore, each negative active material layer 41 contains a negative active material (not shown) consisting of graphite, a binder (not shown) consisting of carboxymethyl cellulose (CMC), and styrene-butadiene rubber (SBR, not shown). When used in a paste, the styrene-butadiene rubber exhibits a higher bonding action than CMC. In forming the negative active material layer, its shape can be appropriately maintained.

In the first embodiment, a weight ratio between the negative active material, the binder, and SBR in each negative active material layer 41 is set to 98:1:1.

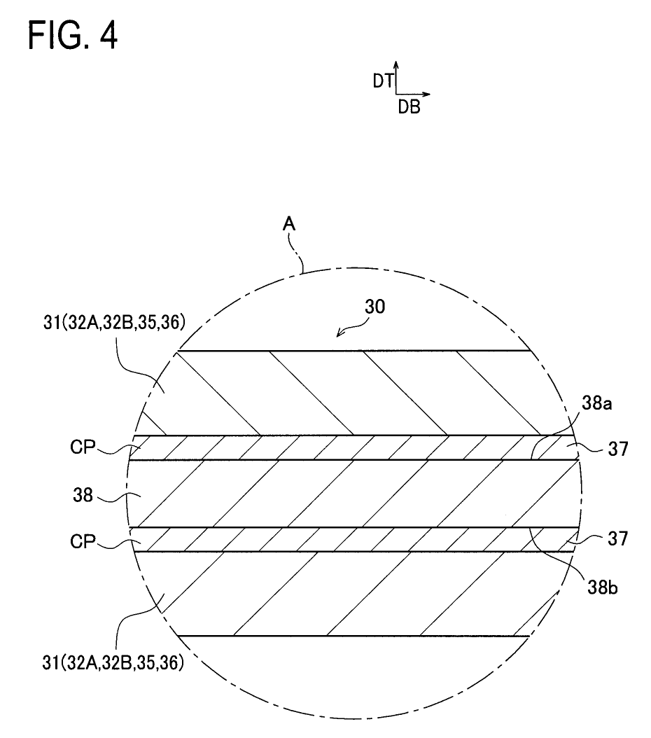

The positive electrode plate 30 of the above power generating element 20 will be explained below with reference to FIGS. 3 and 4.

This positive electrode plate 30 includes, as shown in FIGS. 3 and 4, an aluminum foil 38 made of aluminium, carbon coat layers 37 formed respectively on main surfaces (a first main surface 38a and a second main surface 38b) of the aluminum foil 38, and positive active material layers 31 formed respectively on the carbon coat layers 37.

Each carbon coat layer 37 has a thickness of 2 μm and contains polyvinylidene fluoride (PVDF) not shown as well as carbon particles CP made of acetylene black. A weight ratio (a solid content ratio) of the carbon particles CP and PVDF is set to 30:70.

In forming the positive active material layer 31 mentioned later, the carbon coat layers 37 prevent the active material paste 31P mentioned later from contacting with the aluminum foil 38 and thus from corroding, and assist in physical contact between the aluminum foil 38 and the positive active material layer 31.

Each positive active material layer 31 of the positive electrode plate 30 contain CMC as a first binder 32A and PEO as a second binder 32B but does not contain polytetrafluoroethylene (PTFE), as described later. Accordingly, there is a concern that the peel strength of the active material layers 31 on the aluminum foil 38 decreases. In the first embodiment, however, the carbon coat layers 37 are provided on the aluminum foil 38. With an anchor effect of the carbon coat layers 37, therefore, bonding strength between the aluminum foil 38 and each positive active material layer 31 can be reliably increased. This makes it possible to enhance the peel strength of the active material layers 31 respectively formed on the carbon coat layers 37 and hence hold the active material layers 31 stably on the aluminum foil 38.

In the first embodiment, the positive active material layers 31 in Example 1 do not contain PTFE but do contain only positive active material particles 36 made of LiNi_{0.82}Co_{0.15}Al_{0.03}O₂, a conductive material 35 consisting of acetylene black, and further the first binder 32A (CMC) and the second binder 32B (PEO) as the binder (see FIGS. 3 and 4). The weight ratio between the positive active material particles 36, the conductive material 35, the first binder 32A, and the second binder 32B in each active material layer 31 is set to 87:10:1:1.

Each active material layer 31, which will be described in detail later, is formed in such a way that the positive active material particles 36, the first binder 32A, the second binder 32B, and the conductive material 35 are kneaded with ion-exchange water AQ, forming the active material paste 31P, and this paste 31P is applied and dried, then further compressed.

The inventors made evaluations on the property (battery capacity and battery resistance) of the above battery 1.

As the battery 1, a new (initial) battery 1 just manufactured was tested. To be concrete, in an evaluation test on battery capacity, the battery 1 subjected to constant current charge at a current value of 1 C until the inter-terminal voltage reached 4.1 V (full charged voltage) was discharged with constant current at a current value of 1 C until the terminal voltage became 2.5 V and its discharged electric quantity (battery capacity) was measured. In the evaluation test on battery resistance, after the above battery capacity test, the battery charged at a current value of 1 C until the inter-terminal voltage became 3.537 V (corresponding to a state of charge (SOC) of 30% (assuming that a battery capacity in a voltage range of 2.5 to 4.1V is 100%)), and then the battery was charged by gradually decreasing the current value from 1 C to 0.02 C while maintaining the voltage constant (charge with constant voltage). After a pause of 30 seconds, the constant current discharge at a current value of 30 C was performed and the voltage value at tenth second from the discharge start was measured. At that time, the battery resistance value was calculated by Ohm's law.

The battery 1 subjected the above test took a cycle test in which constant current charge and constant current discharge (each being applied with a current value of 1 C) were repeated in a voltage range of 2.5 to 4.1 V. To be concrete, a pair of charge and discharge was assumed as one cycle and this cycle was continuously repeated 2000 cycles.

Thereafter, a battery resistance value of the battery 1 was measured in a similar manner to the above. A battery resistance change rate of the battery 1 after the cycle test was calculated. This battery resistance change rate is obtained by dividing a battery resistance value after the cycle test by a battery resistance value of a new (initial) battery before the cycle test.

The inventors also measured the peel strength of the positive active material layers 31 of the positive electrode plate 30 in the battery 1. To be concrete, with the use of a tension tester not shown, the positive electrode plate 30 was fixed with double-faced adhesive tape having sufficiently higher viscosity than the peel strength, the positive active material layer 31 was pulled in a direction perpendicular to the positive electrode plate 30, and then the strength thereof was measured.

In addition, batteries 101 and 201 in other examples and batteries C1 and C2 in comparative examples were also produced and subjected to an evaluation test for their properties and measurements of peel strength of their positive electrode plates in a similar manner to the battery 1.

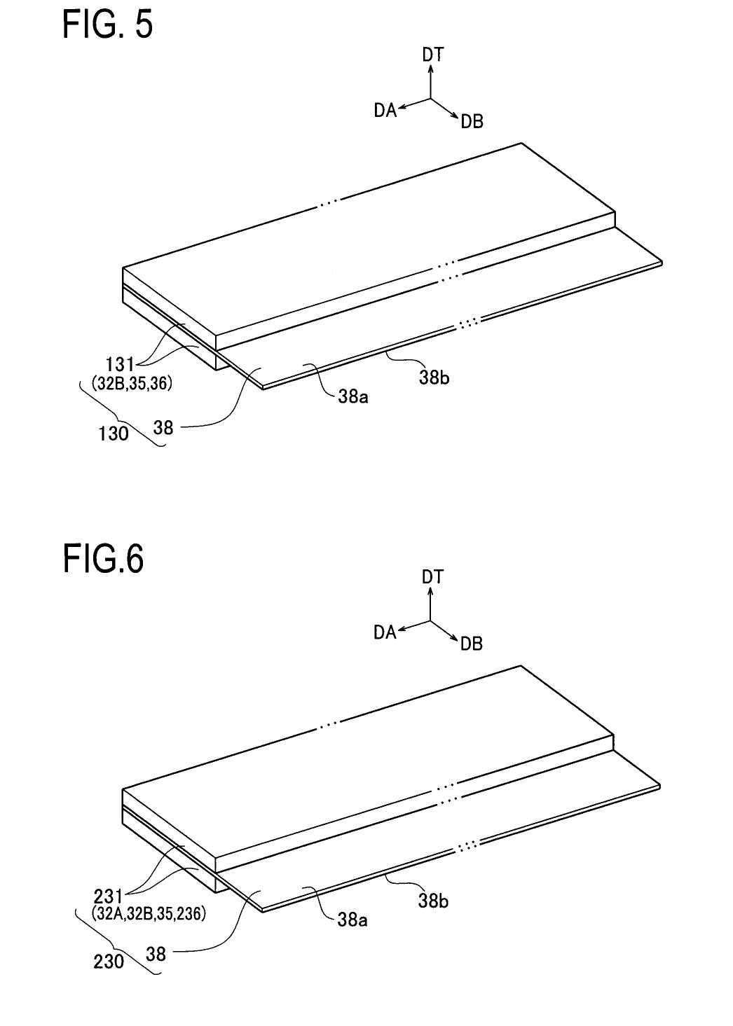

The battery 101 in Example 2 used a positive electrode plate 130 (see FIGS. 1 and 5) having a positive active material layer 131 containing only the second binder 32B (PEO) as the binder in addition to the positive active material particles 36 and the conductive material 35. In this positive active material layer 131, the weight ratio between the positive active material particles 36, the conductive material 35, and the second binder 32B was set to 87:10:2.

The battery 201 in Example 3 used a positive electrode plate 230 (see FIGS. 1 and 6) having a positive active material layer 231 containing positive active material particles 236 made of LiCoO₂ instead of the positive active material particles 36 made of LiNi_{0.82}Co_{0.15}Al_{0.03}O₂, which was used in the battery 1. In this positive active material layer, the weight ratio between the positive active material particles 236, the conductive material 35, the first binder 32A, and the second binder 32B was set to 87:10:1:1.

The battery C1 in Comparative Example 1 used a positive electrode plate having a positive active material layer containing PTFE in addition to the positive active material particles 36, the conductive material 35, the first binder 32A (CMC), and the second binder 32B (PEO). In this positive active material layer, the weight ratio between the positive active material particles 36, the conductive material 35, the first binder 32A, the second binder 32B, and PTFE was set to 87:10:1:1:1.

The battery C2 in Comparative example 2 used a positive electrode plate having a positive active material layer containing only the first binder 32A (CMC) as the binder in addition to the positive active material particles 36 and the conductive material 35. In this positive active material layer, the weight ratio between the positive active material particles 36, the conductive material 35, and the first binder 32A was set to 87:10:2.

Test results of those batteries 1, 101, and 201 and the comparative batteries C1 and C2 are shown in Table 1.

The peel strength of a positive active material layer in a positive electrode plate is represented in terms of relative value (%) with reference to the peel strength of the positive active material layer in the positive electrode plate used in the comparative battery C1.

TABLE 1

| | | | | | | | Peel Strength of |
|---|---|---|---|---|---|---|---|
| | | CMC | PEO | PTFE | Battery | | Positive active |
| | Positive active | (parts by | (parts by | (parts by | Capacity | Battery Resistance | material layer |
| | material | weight) | weight) | weight) | (Ah) | Change Rate (%) | (%) |
| Battery 1 | LiNi_{0.82}Co_{0.15}Al_{0.03}O₂ | 1.0 | 1.0 | 0.0 | 5.23 | 107 | 110 |
| Battery 101 | LiNi_{0.82}Co_{0.15}Al_{0.03}O₂ | 0.0 | 2.0 | 0.0 | 5.19 | 110 | 112 |
| Battery 201 | LiCoO₂ | 1.0 | 1.0 | 0.0 | 4.22 | 110 | 111 |
| Comparative | LiNi_{0.82}Co_{0.15}Al_{0.03}O₂ | 1.0 | 1.0 | 1.0 | 5.20 | 120 | 100 |
| Battery C1 | | | | | | | |
| Comparative | LiNi_{0.82}Co_{0.15}Al_{0.03}O₂ | 2.0 | 0.0 | 0.0 | 5.25 | 112 | 108 |
| Battery C2 | | | | | | | |

According to Table 1, the battery resistance change rates of the batteries 1, 101, and 201 are all smaller than that of the comparative battery C1. It is found from this result that the battery resistance change rate of a battery using a positive electrode plate having a positive active material layer not containing PTFE can be made smaller than that of a battery containing PTFE.

Further, the peel strengths of the positive active material layers 31, 131, and 231 in the positive electrode plates 30, 130, and 230 used in the batteries 1, 101, and 201 are each relatively higher than that of the comparative battery C1. This result reveals that the peel strength of the positive active material layer not containing PTFE can be made higher than the positive active material layer containing PTFE.

Comparing between the batteries 1, 101, 201 and the comparative battery C2, the battery resistance change rates of the batteries 1, 101, 201 are each smaller than that of the comparative battery C2. It is found from this result that the battery resistance change rates of the battery using the positive electrode plate having the positive active material layer containing only PEO as the binder (Battery 1) or only PEO and CMC as the binder (Batteries 101, 201) can be made smaller than that of the battery containing only CMC as the binder (Comparative battery C2).

Further, the peel strengths of the active material layers 31, 131, 231 of the positive electrode plates 30, 130, 230 used respectively in the batteries 1, 101, and 201 are each relatively higher than that of the comparative battery C2. This result reveals that the peal strength of the positive active material layer containing only PEO or only PEO and CMC as the binder can be made higher than that of the positive active material layer containing only CMC as the binder.

Therefore, the positive electrode plates 30, 130, and 230 of the batteries 1, 101, and 201 can achieve improved peel strength of the positive active material layers 31 and thus prevent an increase in battery resistance as compared to the comparative battery C1, i.e., a battery including a positive active material layer containing PTFE as the binder or the comparative battery C2, i.e., a battery including a positive active material layer containing only CMC as the binder.

According to Table 1, when the battery 1 and the battery 101 both of which contain the same positive active material particles 36 in respective positive active material layers, the battery 1 using the positive electrode plate 30 including the positive active material layer 31 containing only PEO and CMC as the binder could be made smaller in battery resistance change rate than the battery 101 using the positive electrode plate 130 including the positive active material layer 131 containing only PEO as the binder.

Similarly, it is found that the battery 201 in Example 3 containing LiCoO2 as the positive active material can be made smaller in battery resistance change rate than a battery (the details of its property are not shown) containing LiCoO₂ as the positive active material in the battery 101 in Example 2.

This shows that it is more preferable to use the positive electrode plates 30 and 230 including the positive active material layers using the binder consisting of only PEO and CMC.

The battery resistance change rate of the battery 1 is smaller than not only those of the comparative batteries C1 and C2 but also that of the battery 101. This reveals that it is particularly preferable to use the positive electrode plate 30 including the positive active material layer 31 containing, as the binder, the first binder 32A (CMC) and the second binder 32B (PEO) respectively by 1 wt %. This reason is conceivable as below. If only CMC is contained, a coating amount of each positive active material particle is small, causing deterioration of the surface of each positive active material particle. Reversely, if only PEO is contained, a coating amount of each positive active material particle is large, decreasing the area that gets involved in battery reaction, in a surface area of each particle. If such a battery is repeatedly charged and discharged, the inside of each positive active material particle is liable to deteriorate.

Further, the battery 1 using the positive electrode plate 30 including the positive active material layer containing PEO and CMC respectively by 1 wt % can prevent battery resistance from increasing.

A method of manufacturing the battery 1 using the positive electrode plate 30 in the first embodiment will be described below referring to the drawings.

The carbon coat layers 37 are first formed on the aluminum foil 38. In this process, by use of 30 parts by weight of acetylene black forming carbon particles CP and a PVDF/NMP solution with a solid content ratio of 13% prepared by mixing PVDF with n-methyl pyrrolidone (NMP), a paste for carbon coat layer not shown is produced by uniformly mixing them so that a solid content ratio of acetylene black and PVDF is 30:70.

This carbon coat layer paste (not shown) is applied on both surfaces (the first main surface 38a and the second main surface 38b) of the aluminum foil 38 with a thickness of 15 μm by a gravure coater and then dried to form the carbon coat layers 37.

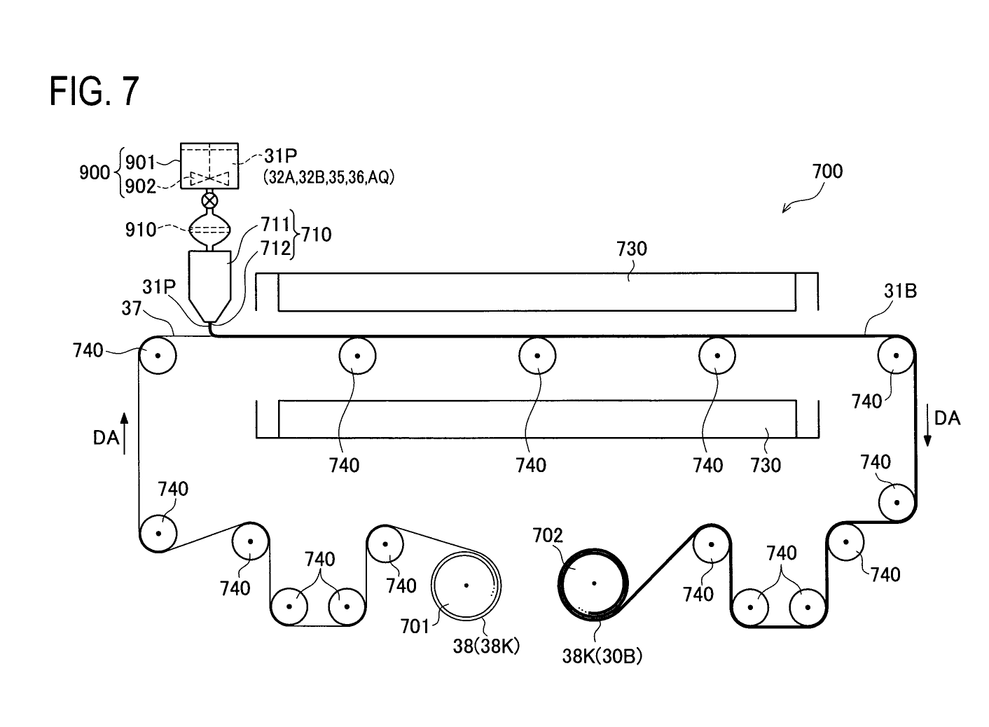

A process of forming the active material paste 31P by mixing and kneading the positive active material particles 36, the conductive material 35, the first binder 32A, and the second binder 32B will be explained referring to FIG. 7.

In this process, a kneading machine 900 provided with a mixing tank 901 and an agitating blade 902 is used. The agitating blade 902 operates to agitate contents or ingredients stored in the tank 901 while shearing them.

In this process, 87 parts by weight of the positive active material particles 36, parts by weight of the conductive material 35, 1 part by weight of CMC forming the first binder 32A, 1 part by weight of PEO forming the second binder 32B, and 85 parts by weight of ion-exchange water AQ are put in the mixing tank 901 of the kneading machine 900 in which they are mixed by the agitating blade 902. In this way, the uniform active material paste 31P is produced.

A filtering process of passing the active material paste 31P after kneading through a filter 910 will be explained below referring to FIG. 7. The filter 910 used in this filtering process is a multilayered roll filter (a trapping efficiency of 90%=40 μm) made of polypropylene nonwoven. This filter 910 is placed between the above kneading machine 900 and a die 710 of a coating device 700 mentioned later.

In this filtering process, the active material paste 31P prepared by the kneading machine 900 is passed through the filter 910 to remove foreign substances included in the active material paste 31P. The active material paste 31P passing through the filter 910 is stored in a paste holder 711 of the die 710.

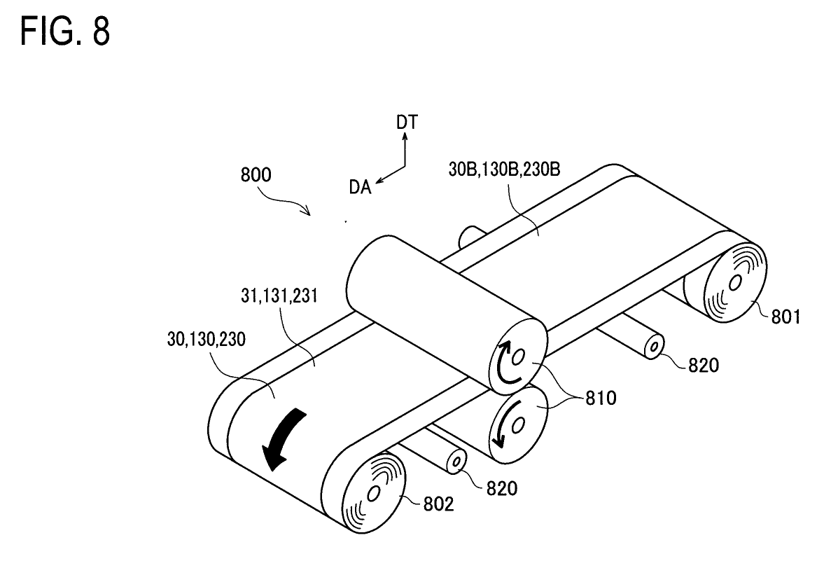

A next process of forming a positive active material layer will be explained referring to FIG. 7, in which the active material paste 31P prepared by kneading the positive active material particles 36, conductive material 35, first binder 32A, and second binder 32B is applied on the aforementioned carbon coat layers 37 and then dried to form the positive active material layers 31. This positive active material layer forming step includes an applying step using an applying device 700 shown in FIG. 7 and a press step using a press machine 800 shown in FIG. 8.

The applying step using the applying device 700 is first explained. This applying device 700 is provided with a wind-off part 701, the die 710, heaters 730, a wind-up part 702, and a plurality of auxiliary rollers 740 (see FIG. 7).

The die 710 includes the metal paste holder 711 that internally stores the active material paste 31P having passed through the filter 910, and a discharging port 712 for continuously discharging the active material 31P from the holder 711 toward the carbon coat layer 37.

This discharging port 712 opens in a slit shape extending in parallel to a width direction (a depth direction to the drawing sheet of FIG. 7) of the aluminum foil 38 to supply the active material paste 31P in a strip shape onto each of the carbon coat layers 37 formed respectively on both surfaces of the aluminum foil 38 moving in a longitudinal direction DA.

Further, the heaters 730 are used to heat the aluminum foil 38 and the active material paste 31P applied on this aluminum foil 38. While moving through between two heaters 730, the paste 31P applied on the carbon coat layer 37 gets dried gradually. At the time of completely passing through between the heaters 730, the paste 31P has been fully dried, that is, the ion-exchange water AQ in the paste 31P has been fully vaporized.

Now, the applying step will be explained.

A strip-shaped aluminum foil 38 (Thickness: 15 μm) wound around the wind-off part 701 is wound off in the longitudinal direction DA. It is to be noted that both surfaces of this aluminum foil 38 have been applied respectively with the carbon coat layers 37 in advance. On one carbon coat layer 37 applied on such a foil 38, the active material paste 31P is applied by the die 710.

Then, this paste 31P is dried by the heaters 730 to form an uncompressed active material layer 31B. A one-side supported aluminum foil 38K carrying this uncompressed active material layer 31B on the carbon coat layer 37 on one side is temporarily wound up on the wind-up part 702.

By using this applying device 700 again, the active material paste 31P is applied on the carbon coat layer 37 on the other side of the one-side supported aluminum foil 38K (the aluminum foil 38), the other side not yet carrying an uncompressed active material layer 31B. This paste 31P is fully dried by the heaters 730. Thus, an unpressed active material laminated plate 30B is produced, in which the uncompressed active material layers 31B are laminated respectively on the carbon coat layers 37 on both surfaces of the aluminum foil 38.

Of the positive active material layer forming process, the press step using the press machine 800 will be explained referring to FIG. 8.

The press machine 800 is provided with a wind-off part 801, press rollers 810, a wind-up part 802, and a plurality of auxiliary rollers 820. With this press machine 800, the unpressed active material laminated plate 30B is wound off from the wind-off part 801 to pass through between two rollers 810 whereby the plate is compressed in a thickness direction DT.

In this way, a positive electrode plate 30 is produced, in which two positive active material layers 31 compressed are laminated respectively on both surfaces of the aluminum foil 38 (see FIGS. 3 and 4).

Meanwhile, the inventors investigated changes in viscosity of active material paste according to the elapsed time (standing time) from the time of manufacturing.

To be specific, in relation to the active material paste 31P, that is, the active material paste 31P containing the first binder 32A (CMC) and the second binder 32B (PEO) as the binder, the viscosity was measured respectively at standing times of 0 h (just after manufacturing), 24 h, 48 h, 72 h, and 96 h.

On the other hand, as a comparison with the active material paste 31P, the viscosity of the active material paste (comparative paste EP) containing the first binder 32A (CMC) only as the binder was measured respectively at standing times of 0 h (just after manufacturing), 24 h, and 48 h.

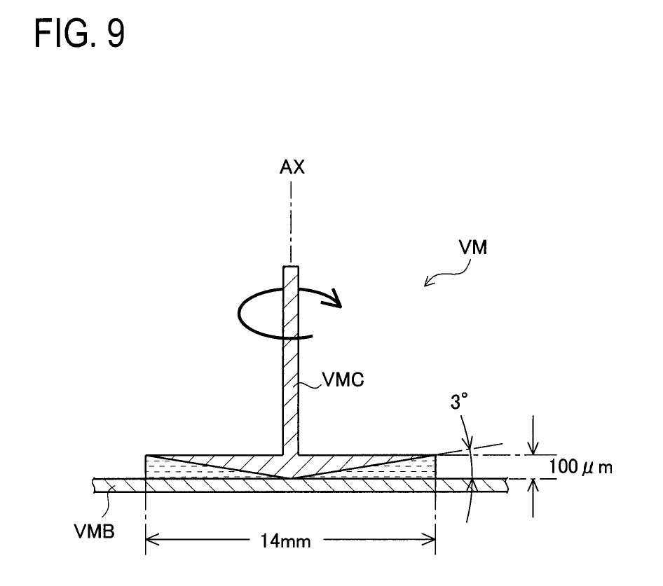

For measuring the viscosity of the active material paste, an E-type viscometer VM shown in FIG. 9 was used. This E-type viscometer VM is a rotary viscometer including a conical plate VMC having a conical surface (Outer diameter: 14 mm, Cone angle: 3°) and being rotatable about a central axis AX, and a flat board VMB vertical to the central axis AX.

For measurement of the viscosity of the active material paste 31P, firstly, the active material paste 31P just manufactured was put on the board VMB of the viscometer with a gap of 100 μm in a constant-temperature bath of 30° C. The conical plate VMC was moved from above the paste 31P until a vertex of the conical plate VMC came into contact with the board VMB. Thereafter, the conical plate VMC was rotated about the central axis AX at a constant speed, i.e., at a shearing speed (a rotation speed) of 1 rpm, and then the viscosity of the active material paste 31P was measured. Further, the viscosity at each standing time of 24 h, 72 h, and 96 h was also measured.

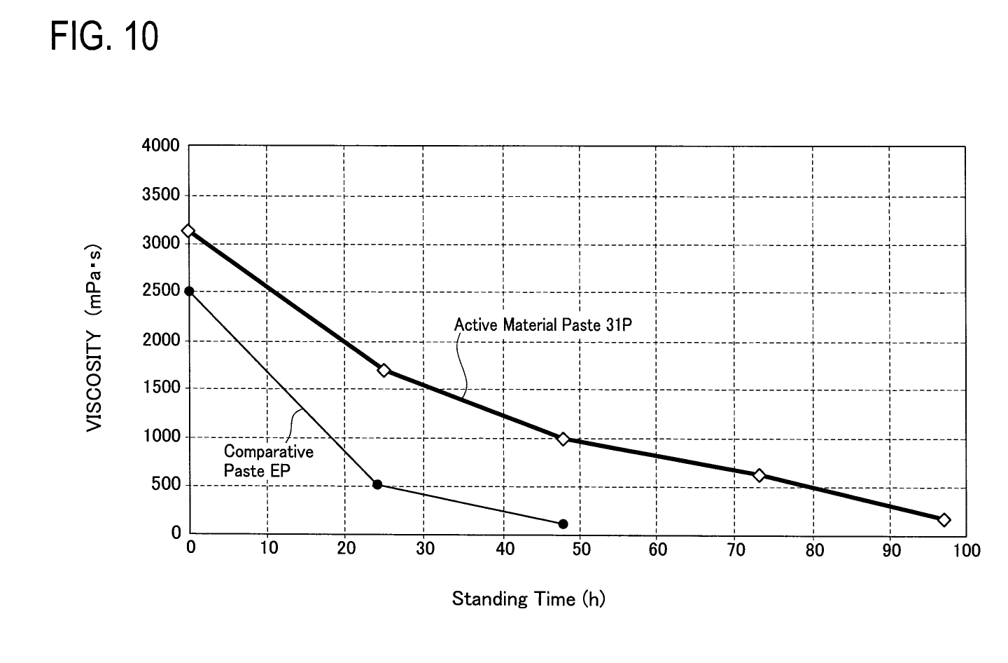

With respect to a comparative paste EP in Comparative Example, the viscosity at each standing time of 0 h, 24 h, and 48 h was measured in a similar manner to the measurement on the active material paste 31P. The results thereof are shown in FIG. 10.

A graph in FIG. 10 shows changes in viscosity of each active material paste according to the length of standing time.

Comparing at a standing time of 0 h, that is, just after manufacturing, the viscosity of the active material paste 31P is higher than the viscosity of the comparative paste EP. This reveals that the use of not only CMC but also PEO as the binder of the active material paste can improve the viscosity of the active material paste.

Accordingly, even when the active material paste 31P containing PEO and CMC as the binder is applied on the carbon coat layers 37 in the above applying step, it is possible to prevent this paste 31P from spreading beyond the applied area or flowing down from the aluminum foil 38 before the paste 31P is dried by the heaters 730. Specifically, in the manufacturing method in the first embodiment, the positive electrode plate 30 can be manufactured in which each positive active material layer 31 maintaining its appropriate shape is formed on the aluminum foil 38 (the carbon coat layer 37).

Since the positive active material paste 31P is applied on the carbon coat layers 37 formed on the aluminum foil 38 in the positive active material layer forming process, the bonding strength between the formed positive active material layers 31 and the aluminum foil 38 can be reliably enhanced by the anchor effect of the carbon coat layers 37.

According to the graph in FIG. 10, the active material paste 31P and the comparative paste EP are both decreased in viscosity as the standing time advances. This may result from the following reasons. The positive active material particles 36 contained in each paste (the active material paste 31P and the comparative paste EP) exhibit alkaline properties. In association therewith, the viscosity of CMC may gradually decrease as time passes.

As In the active material paste 31P, however, the viscosity decreasing speed (obtained by dividing a viscosity change amount by a standing time) is lower than that of the comparative paste EP. Specifically, the paste 31P has the viscosity that slowly decreases over time. This is conceivably because PEO in the active material paste 31P has higher alkaline properties as compared to CMC and the viscosity of PEO is maintained in the paste 31P.

Thus, when the active material paste 31P is used in the aforementioned applying step, the viscosity of the paste 31P less changes over time. Even when a number of positive electrode plates 30 are manufactured, the thickness of the positive active material layers 31 is less likely to vary. Further, such a positive electrode plate 30 can be manufactured effectively.

Separately from the aforementioned positive electrode plate 30, the negative electrode plate 40 is manufactured. To be specific, 98 parts by weight of graphite powder, 81 parts by weight of an aqueous solution with 1.23 wt % of CMC (i.e., 1 part by weight of CMC), and 4 parts by weight of ion-exchange water are mixed. Further, 70 parts by weight of ion-exchange water are added and uniformly kneaded. Thereafter, 1 part by weight of styrene-butadiene rubber (SBR) is added and agitated, producing a negative paste (not shown). On the other hand, alumina and a binder are added into an acrylate resin/NMP solution with a solid content ratio of 10% prepared by uniformly mixing acrylate resin with NMP with a solid content ratio of alumina to the binder of 95:5, thereby producing a ceramic paste not shown.

The above negative paste is applied on both surfaces of a copper foil 48 having a thickness of 10 μm by a die coater, and then dried and pressed together with the copper foil 48, forming a negative active material layer 41. On this negative active material layer 41, the ceramic paste is applied by a common gravure coater. This paste is then dried, forming a ceramic coat layer 42. In this way, the negative electrode plate 40 is completed (see FIG. 2).

The positive electrode plate 30 and the negative electrode plate 40 manufactured as above are wound while interposing therebetween the separator 50 having a thickness of 20 μm to form the power generating element 20. Further, the positive current collector 71 and the negative current collector 72 are welded respectively to the positive electrode plate 30 (the aluminum foil 38) and the negative electrode plate 40 (the copper foil 48). This assembly is inserted in the battery case body 11. An electrolyte not shown is then poured in the case body 11 and then the closing lid 12 is sealingly welded to the case body 11. Thus, the battery 1 is completed (see FIG. 1).

The method of manufacturing the positive electrode plate 30 in the first embodiment includes the positive active material layer forming process in which the active material paste 31P containing only the first binder 32A (CMC) and the second binder 32B (PEO) as the binder, not containing PTFE, is applied on the aluminum foil 38 (each carbon coat layer 37) and dried to form the positive active material layers 31. This method can manufacture the aforementioned battery 1 in Table 1, that is, the positive electrode plate 30 of the battery 1 with good peel strength and capable of preventing its battery resistance from increasing.

In addition, since the battery 1 uses the positive electrode plate 30 including the positive active material layers 31 containing only the first binder 32A (CMC) and the second binder 32B (PEO) as the binder, the battery 1 can prevent an increase in battery resistance (see Table 1 mentioned above). Since the active material paste 31P does not contain PTFE, no aggregates will be generated in the active material paste 31P and the paste 31P can be applied thinly and uniformly.

The active material paste 31P does not contain PTFE. Accordingly, in the active material paste 31P, the aggregates deriving from PTFE particles and the conductive material 35 consisting of acetylene black are not generated.

According to this method of manufacturing the positive electrode plate, including the aforementioned filtering process, it is possible to remove foreign substances by the filter 910 and further efficiently remove the foreign substances without clogging with the aggregates.

The method of manufacturing the positive electrode plate 130 of the battery 101 in Example 2 and the method of manufacturing the positive electrode plate 230 of the battery 201 in Example 3 are identical to the above method of manufacturing the positive electrode plate 30 of the battery 1, except for the active material paste used in the applying step of the positive active material layer forming process. Thus, identical parts will not be described below.

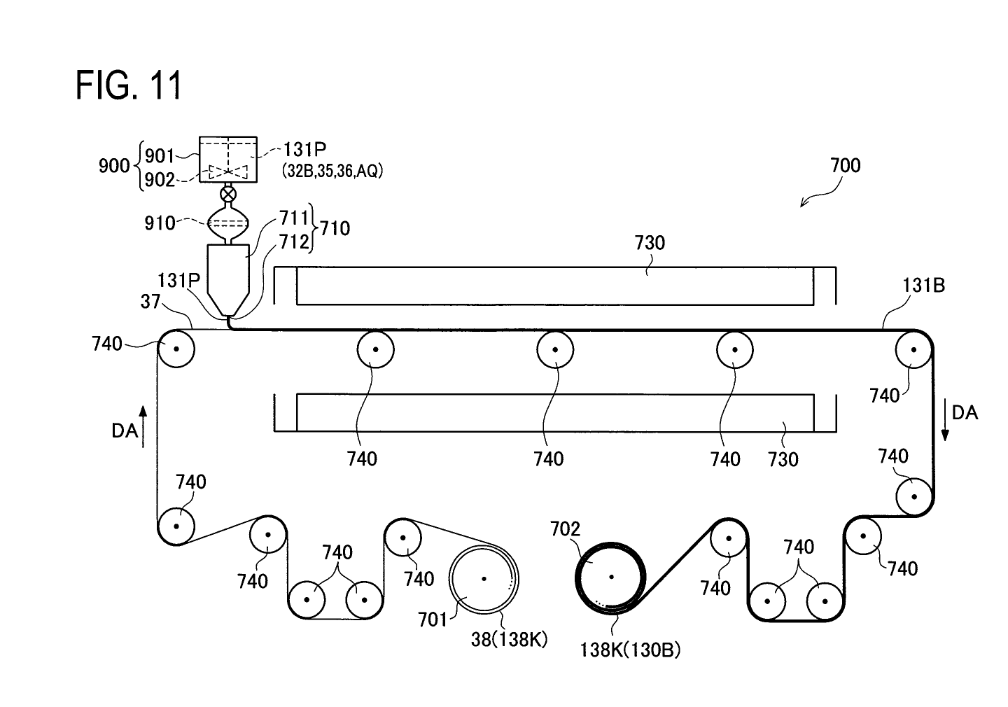

In the method of manufacturing the positive electrode plate 130, an active material paste 131P is prepared by use of the kneading machine 900 shown in FIG. 11. Specifically, 87 parts by weight of the positive active material particles 36, 10 parts by weight of the conductive material 35, 1 parts by weight of the second binder 32B (PEO), and 85 parts by weight of ion-exchange water AQ are put into the mixing tank 901 of the first kneading machine 900 and agitated by the agitating blade 902. In this way, the uniform active material paste 131P is produced.

In the filtering process, successively, the active material paste 131P produced by the kneading machine 900 is passed through the filter 910 shown in FIG. 11 to remove foreign substances mixed in the active material paste 131P.

In the applying step of the positive active material layer forming process for the positive electrode plate 130 of the battery 101, the active material paste 131P is applied on either one of the carbon coat layers 37 formed respectively on both surfaces of the aluminum foil 38 by use of the die 710 of the applying device 700 shown in FIG. 11.

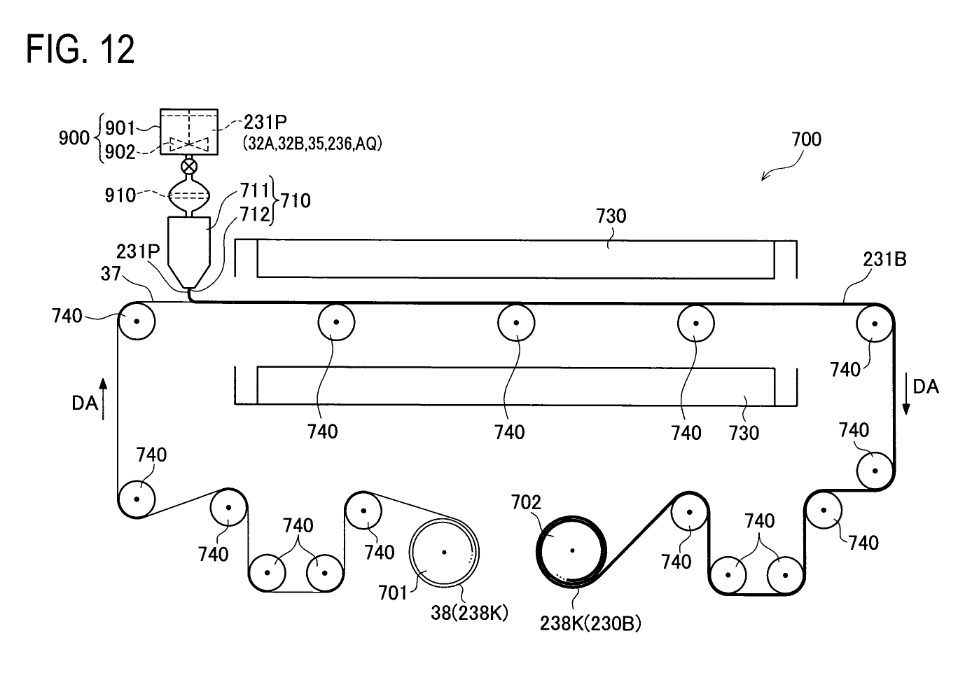

In the method of manufacturing the positive electrode plate 230, an active material paste 231P is prepared by use of the kneading machine 900 shown in FIG. 12. To be specific, 87 parts by weight of positive active material particles 236 made of LiCoO₂ which is different from the above positive active material particles 36 in the battery 1, 10 parts by weight of the conductive material 35, 1 part by weight of the first binder 32A (CMC), 1 part by weight of the second binder 32B (PEO), and 85 parts by weight of ion-exchange water AQ are put in the mixing tank 901 of the first kneading machine 900 and mixed by the agitating blade 902. In this way, the uniform active material paste 231P is produced.

In the filtering process, the active material paste 231P prepared by the kneading machine 900 is passed through the filter 910 shown in FIG. 12 to remove foreign substances mixed in the paste 231P.

In the applying step of the positive active material layer forming process for the positive electrode plate 230 of the battery 201, the active material paste 231P is applied on either one of the carbon coat layers 37 formed respectively on both surfaces of the aluminum foil 38 by use of the die 710 of the applying device 700 shown in FIG. 12.

### First Referential Embodiment

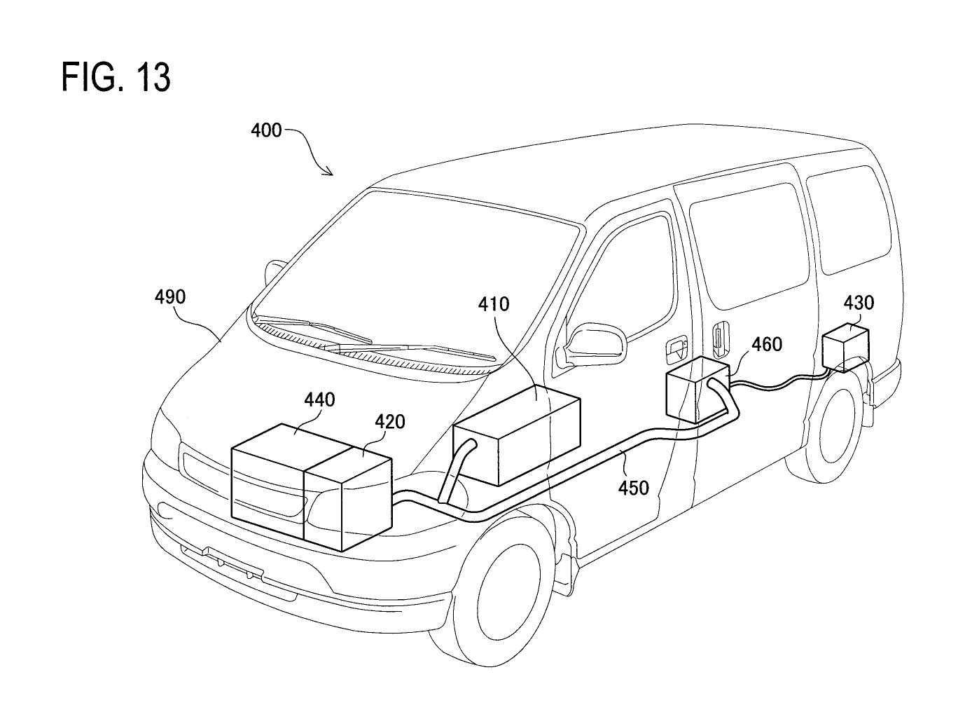

A vehicle 400 in a first referential embodiment has a plurality of the batteries 1 mounted described above. Specifically, as shown in FIG. 13, the vehicle 400 is a hybrid electric vehicle to be driven by using an engine 440, a front motor 420, and a rear motor 430, in combination. This vehicle 400 includes a vehicle body 490, the engine 440, the front motor 420 attached thereto, the rear motor 430, a cable 450, an inverter 460, and an assembled battery 410 containing a plurality of batteries 1, 101, or 201.

The vehicle 400 in the first referential embodiment mounts the batteries 1, 101, or 201, that is, the batteries 1, 101, or 201 using the aforementioned positive electrode plates 30, 130, or 230. Accordingly, the vehicle 400 can prevent deterioration of its driving performance.

### Second Referential Embodiment

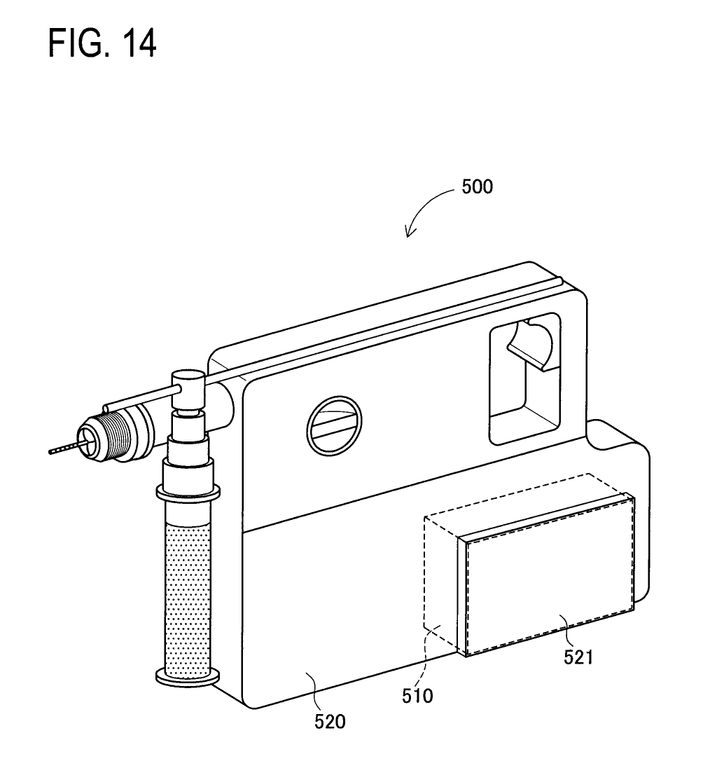

A hammer drill 500 in a second referential embodiment mounts a battery pack 510 containing the aforementioned battery 1, 101, or 201. As shown in FIG. 14, this hammer drill 500 is a battery-mounting device including the battery pack 510 and a main body 520. The battery pack 510 is removably housed in a pack housing part 521 of the main body 520 of the hammer drill 500.

The hammer drill 500 in the second referential embodiment mounts the battery 1, 101, or 201, that is, the battery 1, 101, or 201 using the aforementioned positive electrode plate 30, 130, or 230. Thus, the hammer drill 500 can prevent deterioration of the property.

The present invention is explained along the first embodiment but is not limited thereto. The invention may be embodied in other specific forms without departing from the essential characteristics thereof.

Even though the first embodiment uses for example acetylene black as the carbon powder to be contained in the carbon coat layer, other carbon black than acetylene black, for example, furnace black, ketchen black, etc. and graphite powder and others may also be used. Although the positive electrode plate uses the conductive material consisting of acetylene black, for example, the aforementioned carbon powder excepting acetylene black, metal powder such as nickel powder may also be used.

For the positive active material particles, not only lithium nickel-cobalt oxide but also other lithium transition metal complex oxide particles such as lithium cobalt oxide, lithium nickel oxide, and lithium manganate oxide, or iron-olivine compound may also be used.

1. A positive electrode plate including:
a substrate made of aluminum; and
a positive active material layer formed on the substrate, the layer containing positive active material particles, a conductive material, and a binder,
wherein a carbon coat layer containing carbon powder is interposed between the substrate and the positive active material layer, and
wherein the binder consists of polyethylene oxide or polyethylene oxide and carboxymethyl cellulose.

2. (canceled)

3. The positive electrode plate according to claim 1,
wherein the binder consists of only polyethylene oxide and carboxymethyl cellulose.

4. The positive electrode plate according to claim 1,
wherein the positive active material layer contains the polyethylene oxide and the carboxymethyl cellulose respectively by 1 wt %.

5. A battery using the positive electrode plate described in claim 1, and
a negative electrode plate including: a copper substrate for negative electrode plate, a negative active material layer containing negative active material particles consisting of graphite and a binder; and a ceramic coat layer formed on the negative active material layer,
wherein when, before and after a cycle test in which constant current charge and constant current discharge are repeated alternately 2000 times each at a current value of 1 C in a range of 0 to 100% of a state of charge (SOC) of the battery, the battery in 30% SOC is subjected to the constant current discharge at a current value of 30 C, a voltage value at a lapse of ten seconds from a start of discharge is measured, and resistance values of the battery before and after the cycle test are calculated respectively,
a battery resistance change rate calculated by dividing the resistance value after the cycle test by the resistance value before the cycle test is in a range of 100% to 110%.

6. (canceled)

7. (canceled)

8. A method of manufacturing a positive electrode plate including:
a substrate made of aluminum; and
a positive active material layer formed on the substrate, the layer containing positive active material particles, a conductive material, and a binder,
wherein a carbon coat layer containing carbon powder is interposed between the substrate and the positive active material layer,
wherein the binder consists of polyethylene oxide or polyethylene oxide and carboxymethyl cellulose, and
wherein the method includes a positive active material layer forming process of forming the positive active material layer by: applying, onto the carbon coat layer formed in advance on the substrate, an active material paste prepared by kneading the positive active material particles, the conductive material, and the binder, and; then drying the active material paste.

9. (canceled)

10. The method of manufacturing a positive electrode plate according to claim 8, including:
prior to the positive active material layer forming process,
a filtering process of passing the kneaded active material paste through a filter, the filter having an index of trapping efficiency of 90% being 50 μm or less.

11. The positive electrode plate according to claim 1,
wherein the positive active material layer contains the polyethylene oxide and the carboxymethyl cellulose respectively by 1 wt %.

12. A battery using the positive electrode plate described in claim 3, and
a negative electrode plate including: a copper substrate for negative electrode plate, a negative active material layer containing negative active material particles consisting of graphite and a binder; and a ceramic coat layer formed on the negative active material layer,
wherein when, before and after a cycle test in which constant current charge and constant current discharge are repeated alternately 2000 times each at a current value of 1 C in a range of 0 to 100% of a state of charge (SOC) of the battery, the battery in 30% SOC is subjected to the constant current discharge at a current value of 30 C, a voltage value at a lapse of ten seconds from a start of discharge is measured, and resistance values of the battery before and after the cycle test are calculated respectively,
a battery resistance change rate calculated by dividing the resistance value after the cycle test by the resistance value before the cycle test is in a range of 100% to 110%.

13. A battery using the positive electrode plate described in claim 4, and
a negative electrode plate including: a copper substrate for negative electrode plate, a negative active material layer containing negative active material particles consisting of graphite and a binder; and a ceramic coat layer formed on the negative active material layer,
wherein when, before and after a cycle test in which constant current charge and constant current discharge are repeated alternately 2000 times each at a current value of 1 C in a range of 0 to 100% of a state of charge (SOC) of the battery, the battery in 30% SOC is subjected to the constant current discharge at a current value of 30 C, a voltage value at a lapse of ten seconds from a start of discharge is measured, and resistance values of the battery before and after the cycle test are calculated respectively,
a battery resistance change rate calculated by dividing the resistance value after the cycle test by the resistance value before the cycle test is in a range of 100% to 110%.

14. A battery using the positive electrode plate described in claim 11, and
a negative electrode plate including: a copper substrate for negative electrode plate, a negative active material layer containing negative active material particles consisting of graphite and a binder; and a ceramic coat layer formed on the negative active material layer,
wherein when, before and after a cycle test in which constant current charge and constant current discharge are repeated alternately 2000 times each at a current value of 1 C in a range of 0 to 100% of a state of charge (SOC) of the battery, the battery in 30% SOC is subjected to the constant current discharge at a current value of 30 C, a voltage value at a lapse of ten seconds from a start of discharge is measured, and resistance values of the battery before and after the cycle test are calculated respectively,
a battery resistance change rate calculated by dividing the resistance value after the cycle test by the resistance value before the cycle test is in a range of 100% to 110%.
